(19) United States
(12) Patent Application Publication
(10) Pub. No.: US 2006/0259960 A1
(43) Pub. Date: Nov. 16, 2006

(54) Server, method and program product for management of password policy information

(75) Inventor: Wakako Kondo, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: KABUSHIKI KAISHA TOSHIBA; TOSHIBA SOLUTIONS CORPORATION

(21) Appl. No.: 11/373,136

(22) Filed: Mar. 13, 2006

(30) Foreign Application Priority Data
May 13, 2005 (JP) P2005-141718

(51) Int. Cl. H04L 9/00; H04L 9/32; G06F 17/00; G06F 17/30; H04K 1/00; G06F 15/16; G06F 7/04; G06F 7/58; G06K 19/00; G06K 9/00

(52) U.S. Cl. 726/6; 726/1

(57) ABSTRACT

A password policy information management server 1 according to an embodiment of the present invention includes: a password policy information definition storage section 17a storing the password policy information; a password applying policy information definition storage section 17b storing password applying policy information including timing information; password policy information setting unit 15a configured to allow the administrator of the information system to set each password policy information; a password check unit 15e configured to check validity of the password; and an administrator password change unit 15b configured to request validity checking of a new password to the password check unit 15e according to timing defined by the password applying policy information stored in the password applying policy information definition storage section 17b.

### CROSS REFERENCE TO RELATED APPLICATIONS

This application claims benefit of priority under 35 USC §119 to Japanese Patent Application No. 2005-141718 filed on May 13, 2005, the entire contents of which are incorporated by reference herein.

### BACKGROUND OF THE INVENTION

1. Field of the Invention

The present invention relates to a password policy information management server, a computer implemented method for management of the password policy information, and a program product for the management of the password policy information, at the time of change password.

2. Description of the Related Art

There is a system that urges the user to input the password and login ID when the information system starts. In general, in the information system, password policy information, such as restriction information of the password, is set beforehand by the system administrator.

In such an information system, when a new login ID and a new password are set, whether or not the login ID and the password are valid for password policy information built in the information system is discriminated. As a result of the discrimination, in the case where the password policy information is valid, the new login ID and the password set are registered. As a technique for supporting the setting of policy information, even if the specifications of each software are not understood, the access control policy can be appropriately set and can be maintained. Such a tool is disclosed in Japanese patent Laid Open Publication (Kokai) No. 2004-192601. According to the above tool, the installer of the system can add original security policy information to a set rule of the password.

However, according to the above technique disclosed in Japanese patent Laid Open Publication (Kokai) No. 2004-192601, when the policy information is changed after the system installation, there is a problem that an administrator has to change the setting value and/or has to remodel the program of the information system in itself with the system stopped temporarily. Accordingly, the administrator could not apply the changed password policy information and the changed security policy information to the operation of the information system at any timing.

### SUMMARY OF THE INVENTION

Therefore, the present invention is performed to solve the above-mentioned problem. The embodiments of the present invention provide a password policy information management server, a computer implemented method for management of the password policy information, and a program product for management of the password policy information, which can change the setting value of password policy information and then can apply the changed password policy information without stopping the information system.

In order to solve the above-mentioned problem, the first embodiment of the present invention relates to the server for management of password policy information in order to check validity of a password of an administrator of an information system and a password of a user using the information system. More specifically, the password policy information management server according to the first embodiment of the present invention includes: [a] a storage (17) including a password policy information definition storage section (17a) storing the password policy information used at the time of one of the administrator and the user of the information system deciding the password, and a password applying policy information definition storage section (17b) storing password applying policy information including timing information, the password being possible to be changed, and the timing information applying the password policy information after the changed password; [b] a setting unit (15a) configured to allow the administrator of the information system to set the password policy information, and to store the password policy information in the password policy information definition storage section (17a), said setting unit further configured to allow the administrator of the information system to set the password applying policy information, and to store the password applying policy information in the password applying policy information definition storage section (17b); and [c] a password check unit (15e) configured to read the password policy information stored in the password policy information definition storage section (17a) from the storage (17), and to check validity of the password using the password policy information.

The second embodiment of the present invention relates to the computer implemented method for management of password policy information in order to check validity of a password of an administrator of an information system and a password of a user using the information system. More specifically, the computer implemented method for management of password policy information according to the second embodiment of the present invention includes: [a] allowing the administrator of the information system to set the password policy information used at the time of one of the administrator and the user of the information system deciding the password without stopping the information system, and storing the password policy information in a password policy information definition storage section (17a) included in a storage (17); [b] allowing the administrator of the information system to set password applying policy information including timing information and storing the password applying policy information in the password applying policy information definition storage section (17b) included in the storage (17), said password being possible to be changed, and said timing information applying the password policy information after the changed password; and [c] reading the password policy information stored in the password policy information definition storage section (17a) from the storage (17), and checking validity of the password by a password check unit (15e).

The third embodiment of the present invention relates to the program product for management of password policy information in order to check validity of a password of an administrator of an information system and a password of a user using the information system. More specifically, the program product for management of password policy information according to the third embodiment of the present invention, the computer executable program includes: [a] allowing the administrator of the information system to set the password policy information used at the time of one of the administrator and the user of the information system deciding the password without stopping the information system, and storing the password policy information in a password policy information definition storage section included in a storage; [b] allowing the administrator of the information system to set password applying policy information including timing information and storing the password applying policy information in the password applying policy information definition storage section included in the storage, said password being possible to be changed, and said timing information applying the password policy information after the changed password; and [c] reading the password policy information stored in the password policy information definition storage section from the storage, and checking validity of the password by a password check unit.

According to the password policy information management server, the computer implemented method for management of the password policy information, and the program product for management of the password policy information by the embodiments of the present invention, the setting value of password policy information can be changed without stopping the information system and then this changed password policy information can be applied, by retention of stored the password policy information to the data base built in the information system.

### BRIEF DESCRIPTION OF THE DRAWINGS

FIG. 1 is an illustration showing an example of an overall composition of password policy information management system, according to an embodiment of the present invention.

FIG. 2 is an illustration showing an example of a system structure of a password policy information management server, according to an embodiment of the present invention.

FIG. 3 is an illustration showing an example of a data structure of a table for a password policy information definition, according to an embodiment of the present invention.

FIG. 4 is an illustration showing an example of a data structure of a table for a password applying policy information definition, according to an embodiment of the present invention.

FIG. 5 is an illustration showing an example of a data structure of a table for a user authentication information, according to an embodiment of the present invention.

FIG. 6 is a flow chart showing an example of a setting processing procedure of the password policy performed by an administrator of the information system, according to an embodiment of the present invention.

FIG. 7 is an illustration showing an example of a window of the function menu for the administrator of the information system, according to an embodiment of the present invention.

FIG. 8 is an illustration showing an example of a setting window of the password policy information, according to an embodiment of the present invention.

FIG. 9 is an illustration showing an example of a setting window of the customizing policy information, according to an embodiment of the present invention.

FIG. 10 is a flow chart showing an example of a password change processing procedure performed by the administrator of the information system, according to an embodiment of the present invention.

FIG. 11 is an illustration showing an example of a window of a user retrieval window for the password change function, according to an embodiment of the present invention.

FIG. 12 is an illustration showing an example of a window of the search result for selecting a user, according to an embodiment of the present invention.

FIG. 13 is an illustration showing an example of an input window of a new password for changing the password, according to an embodiment of the present invention.

FIG. 14 is a flow chart showing an example of a password change processing procedure performed by the user of the information system, according to an embodiment of the present invention.

FIG. 15 is a flow chart showing an example of a login authentication processing procedure, according to an embodiment of the present invention.

FIG. 16 is an illustration showing an example of a login window, according to an embodiment of the present invention.

### DETAILED DESCRIPTION OF EMBODIMENTS

Various embodiments of the present invention will be described herein below with reference to the accompanying drawings. It is to be noted that the same or similar reference numerals are applied to the same or similar parts and elements throughout the drawings, and the description of the same or similar parts and elements will be omitted or simplified. However, it is to be noted that the accompanying drawings are anything more than the schematic diagrams.

### EMBODIMENTS

### Embodiments

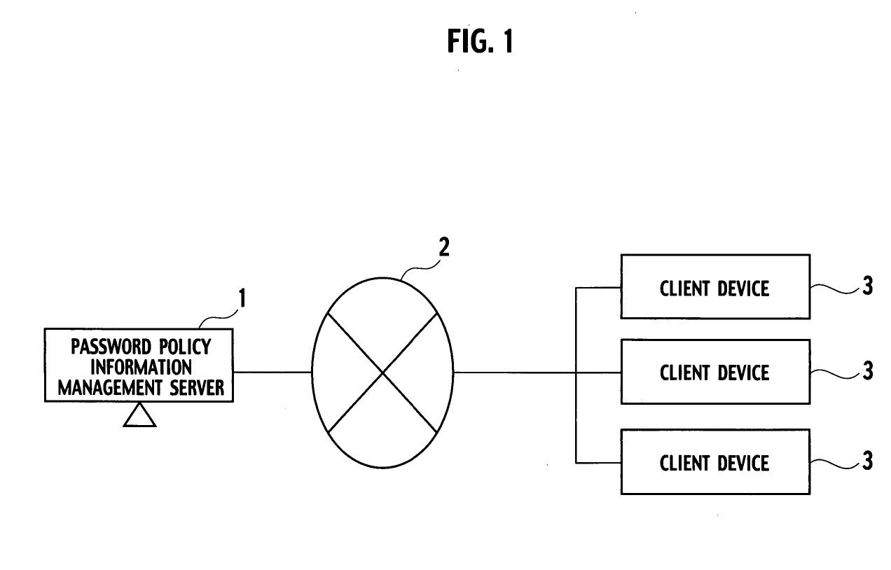

A password policy information management server 1 according to the embodiment of the present invention is used in a password policy information management system as shown in FIG. 1. In this system, the password policy information management server 1 is connected to one or more client device 3 through a communication network 2. The client device 3 is used by a system administrator who manages the system, ordinary system users who set a password and the like. Although not shown in the FIG. 1, the client device 3 is a general computer including an input unit, an output unit, a CPU, a storage, a communication unit and the like. The communication network 2, which is the private lines and/or Internet, etc, is a wired or wireless communication network which can interconnect.

### Password Policy Management Server

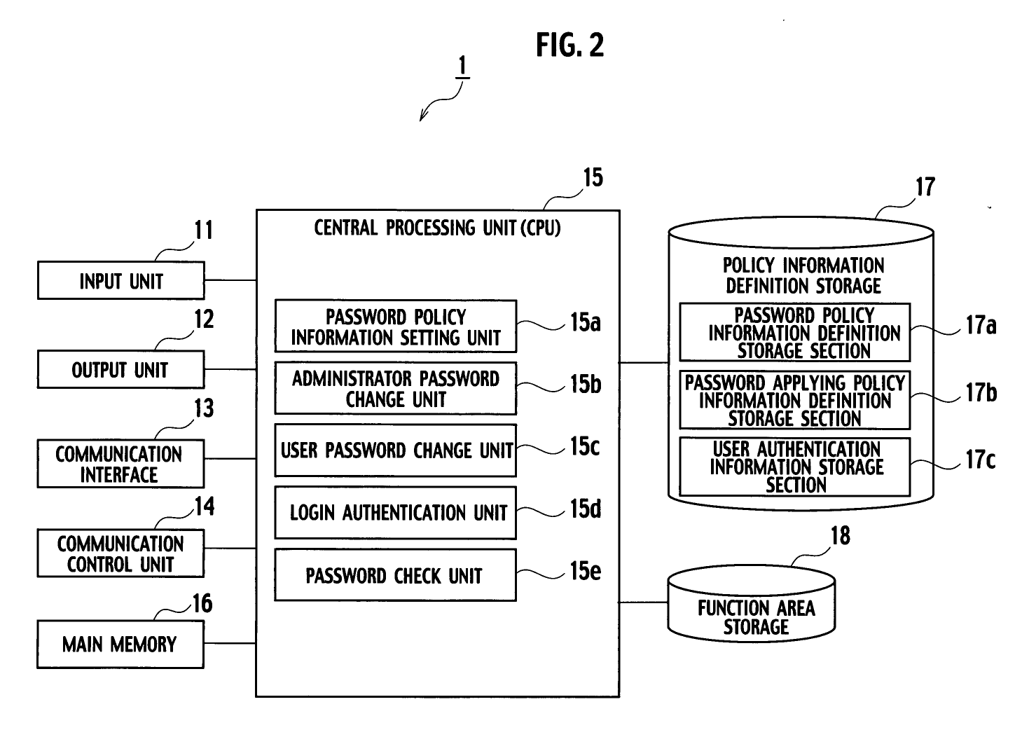

As shown in FIG. 2, the password policy information management server 1 includes an input unit 11, an output unit 12, a communication interface 13, a communication control unit 14, a Central Processing Unit (CPU) 15, a main memory 16, a policy information definition storage 17, and a function area memory 18.

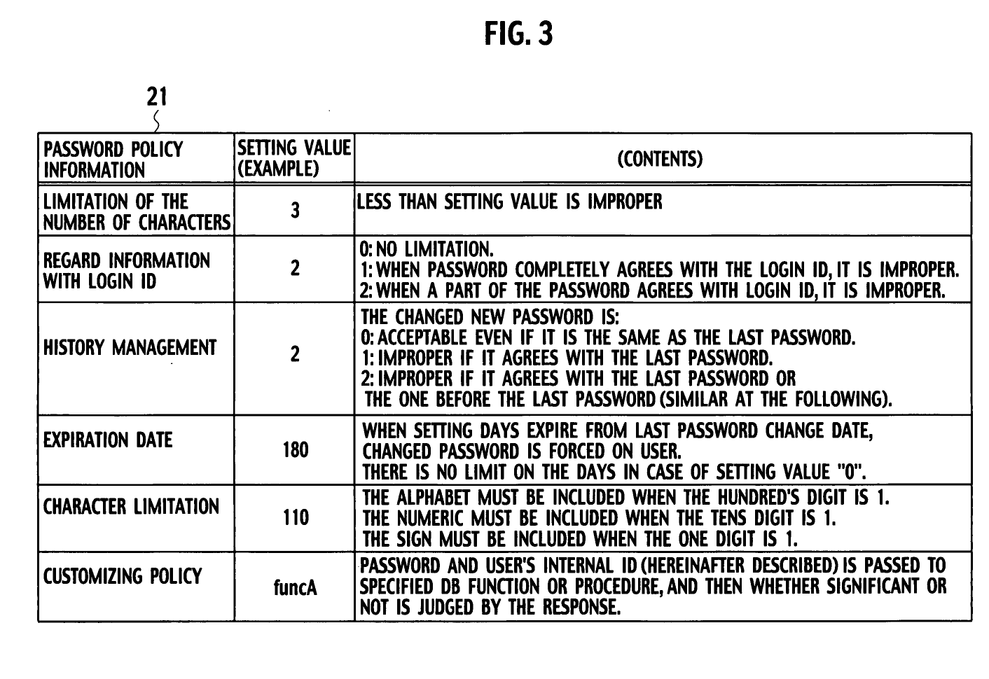

The policy information definition storage 17 includes a password policy information definition storage section 17a, a password applying policy information definition storage section 17b, and a user authentication information storage section 17c. The password policy information definition storage section 17a stores a table 21 for a password policy information definition showed in FIG. 3. Here, the storages are a semiconductor memory, disk storage or the like.

In this embodiment of the present invention, the “password policy information” is restriction information referred to when a new password is decided. The table 21 for the password policy information definition, for example, includes items of limitation information of the number of characters, regard information with login ID, history management information, expiration date information, character limitation information, customizing policy information and the like.

The “limitation information of the number of characters” is information of the limiting value of the number of characters used for the password.

The “regard information with login ID” is information for setting the regard of the digit and character string used for the password and the login ID. For example, in the case where “1: When password completely agrees with the login ID, it is improper.” is set for the “regard information with login ID”, the password policy information management server 1 controls so as not to set the password that becomes completely the same the digit and character strings with the login ID like that both of the password and the login ID are “A23”.

The “history management information” is information for setting the regard of a new password set as a last password which has been used to, when the password is changed. For example, in the case where “1: Improper if it agrees with last time.” is set for the “history management information”, the password policy information management server 1 controls so as not to set the new password when the new password and the last password are the same.

The “expiration date information” is information for the expiration date of the password. When the period of the days set to the “expiration date information” expires, the password policy information management server 1 controls so as to change the current password to the user forcedly.

The “character limitation information” is information for the limitation of the kind of the character used for the password.

The “customizing policy information” is a function and/or a procedure which can be changed or set by the administrator of the information system without permission. When the password and a user's internal ID (explained in detail later) are passed to this customizing policy information, the validity of the password is obtained. The administrator of the information system therefore can change and/or set the customizing policy information without stopping the system.

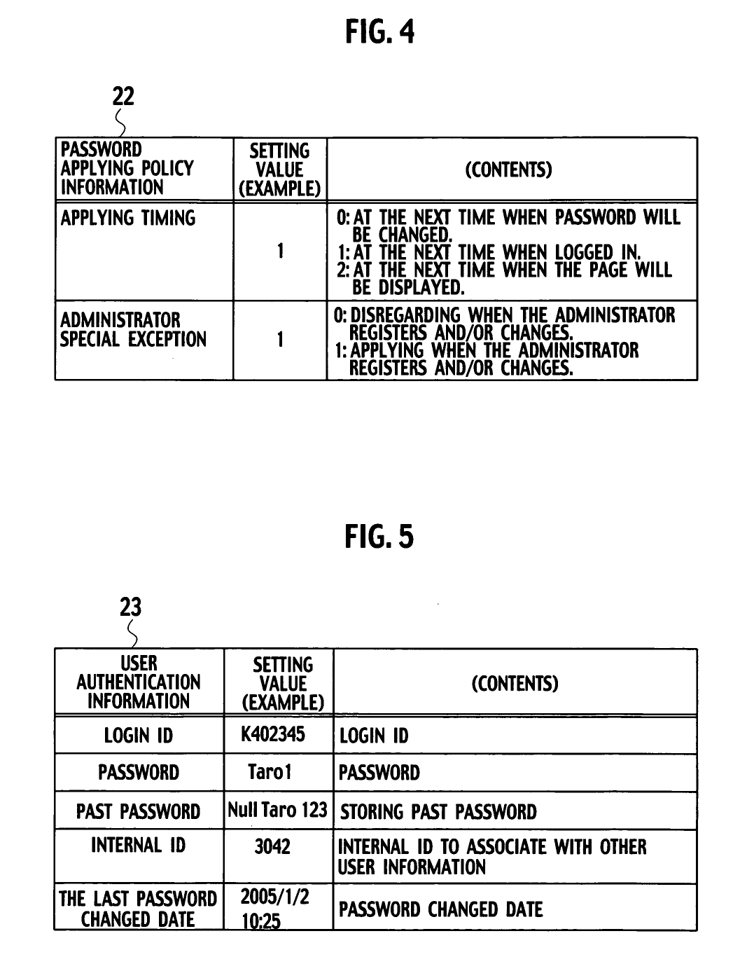

The password applying policy information definition storage section 17b stores a table 22 for a password applying policy information definition as shown in FIG. 4. For example, the table 22 for the password applying policy information definition includes items of applying timing information and administrator special exception information, etc. The “applying timing information” is information for indicating the timing in which this changed password policy information is applied to the user at the time where the password policy information is changed. The “administrator special exception information” is information for indicating whether to apply the password policy information at the time where the administrator registers or changes the user password.

The user authentication information storage section 17c stores a table 23 for a user authentication information as shown in FIG. 5. The table 23 for the user authentication information includes the item such as a login ID, a password, a past password, an internal ID, and the last password changed dates.

The “past password” is the passwords used by each user at the past.

The “internal ID” is ID for relating the login ID to different other user authentication information each user. As other user authentication information, for example, there are a table for relating the internal ID to a postal address and relating a telephone number to a mail address, a table for relating the internal ID to belonging organization, a table for relating the internal ID to organization of an office, and the like. These other user authentication information is related to the internal ID, but is not related to the login ID. As a result, the login ID can correspond to the case assumed to be a changeable. Even if the login ID is changed, which the user can be traced based on the internal ID as a key.

The function area storage 18 is a storage for storing the function and the procedure set by the customizing policy information.

The CPU 15 includes a password policy information setting unit 15a, an administrator password change unit 15b, a user password change unit 15c, a login authentication unit 15d, and a password check unit 15e. The password policy information setting unit 15a, the administrator password change unit 15b, the user password change unit 15c, and the login authentication unit 15d are implemented on the CPU 15 of the password policy information management server 1 by a password policy information management program stored in the recoding medium being executed by the CPU 15, according to the embodiment of the present invention.

The password policy information setting unit 15a is a unit for setting the password policy information stored in the table 21 for password policy information definition as shown in FIG. 3. The password policy information setting unit 15a displays a password policy information setting window 25 on the output unit 12, and allows the user to set the password policy information etc. on the window using the input unit 11.

The administrator password change unit 15b is a unit for changing the user password by the administrator of the information system.

The user password change unit 15c is a unit for allowing the user to change the password. In addition, the administrator can also change the administrator's own password as one of the users using the user password change unit 15c.

The login authentication unit 15d is a unit for authenticating the input login ID and the input password for request of login by the user.

The password check unit 15e is a unit for checking the password according to password policy information stored in the table 21 for the password policy information definition as shown in FIG. 3.

The CPU 15 is connected to the main memory 16 as the main memory. The main memory 16 temporarily stores the program described the procedure of processing and the data processed by the CPU 15. Then, the machine instruction and the data of the program are passed to the CPU 15 according to the request by the CPU 15. Moreover, the data processed by the CPU 15 is written in the main memory 16. The CPU 15 and main memory 16 are connected to an address bus, a data bus, a control signal, and the like.

The input unit 11 is a keyboard, and a mouse, etc. Alternatively, the input unit 11 may be an interface for receiving the input signal from external storage units such as flexible disks and/or hard disks. The output unit 12 is device for outputting the processing result by the CPU 15 etc. Specifically, the output unit 12 is a liquid crystal display, a CRT display, and a printer, etc. The communication interface 13 is a unit for sending and receiving the data between outside devices. The communication control unit 14 generates the control signal in order to send and receive data between outside devices.

### Processing of Password Policy Information Management Server

The primary processing executed by the password policy information management server 1 includes:

“1. Password policy information setting processing”;

“2. Password change processing performed by the administrator”;

“3. Password change processing performed by the user”; and

“4. Login authentication processing”.

In addition to above processing, although the password policy information management server 1 executes a function for register, update or the deletion of the user information, a function for searching for the user information, and the like, these functions omit explaining in the embodiment of the present invention since it is feasible using a well-known technology.

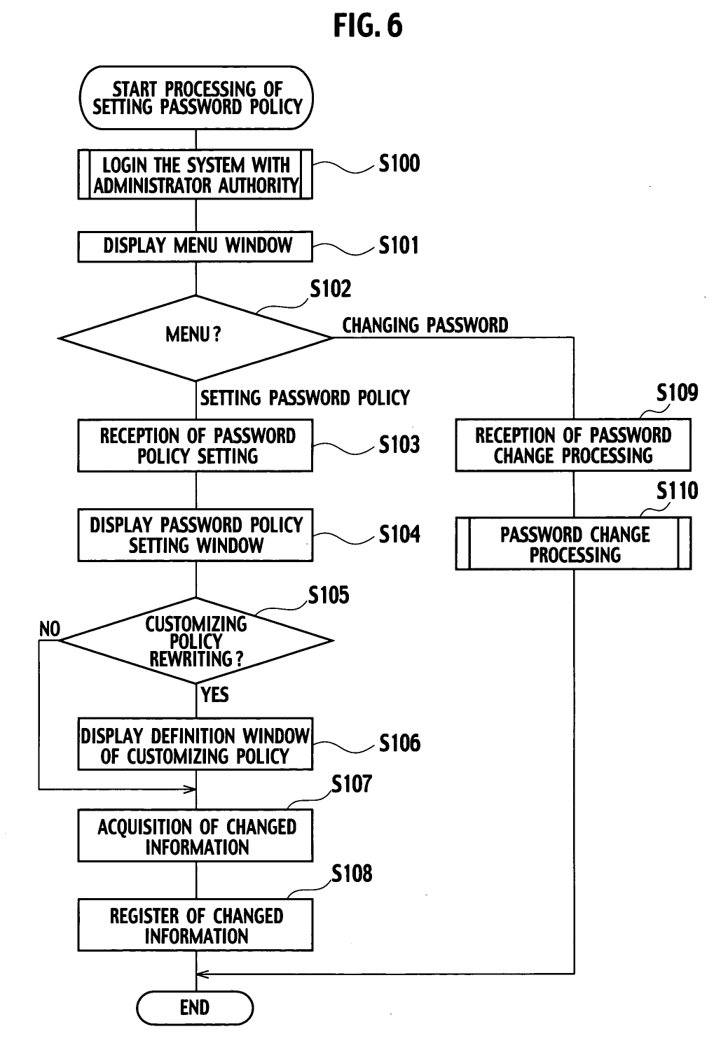

First of all, “1. Password policy information setting processing” performed by the administrator of the information system is described in reference to the flow chart shown in FIG. 6.

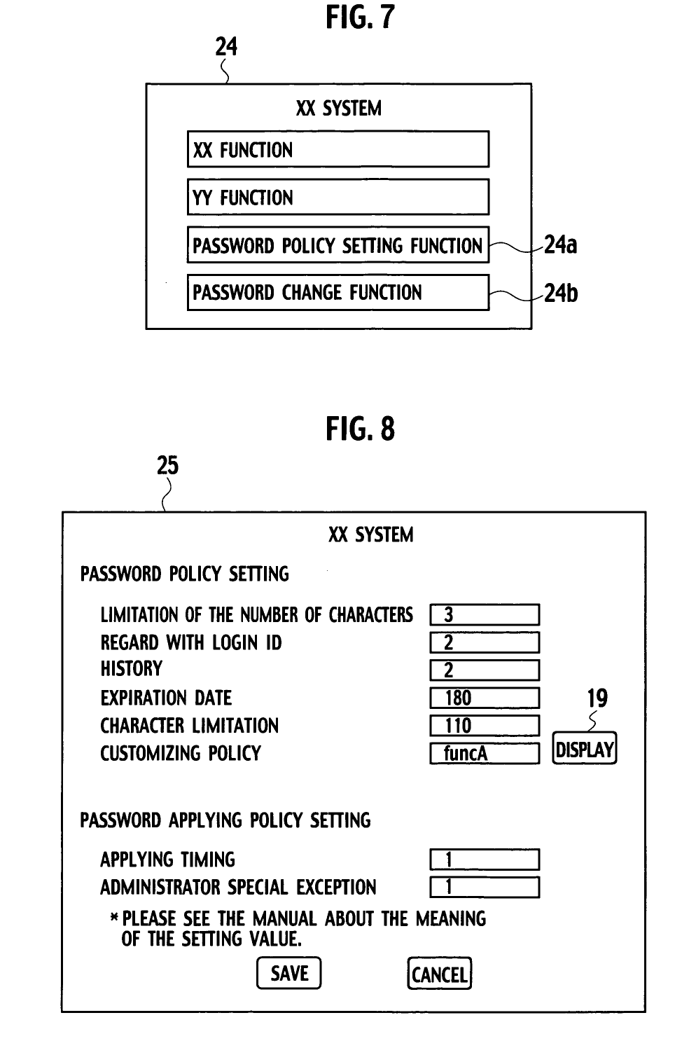

(a) Firstly, in Step 100, the password policy information management server 1 allows to login by the system administrator's authority. By the way, details of the authentication processing of login will be described later. In Step S101, the password policy information management server 1 displays an administrator function menu window 24 shown in FIG. 7 on the output unit 12. A Password policy information setting function button 24a, a password change function button 24b, and the like are placed in the administrator function menu window 24. In Step S102, if the password policy information setting function button 24a is clicked on the administrator function menu window 24 using the input unit 11, this processing goes to Step S103. On the other hand, in Step S102, if the password change function button 24b is clicked on the administrator function menu window 24 using the input unit 11, this processing goes to Step S109.

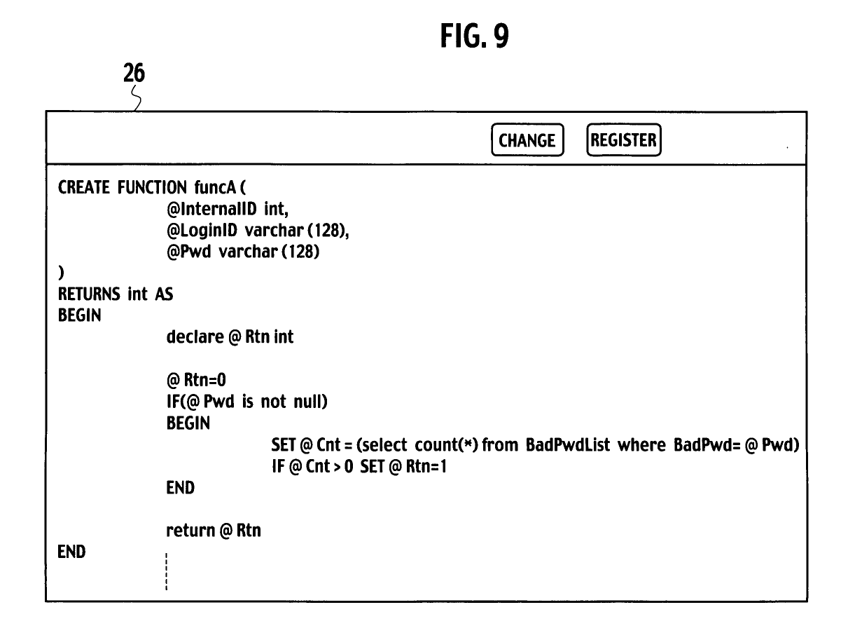

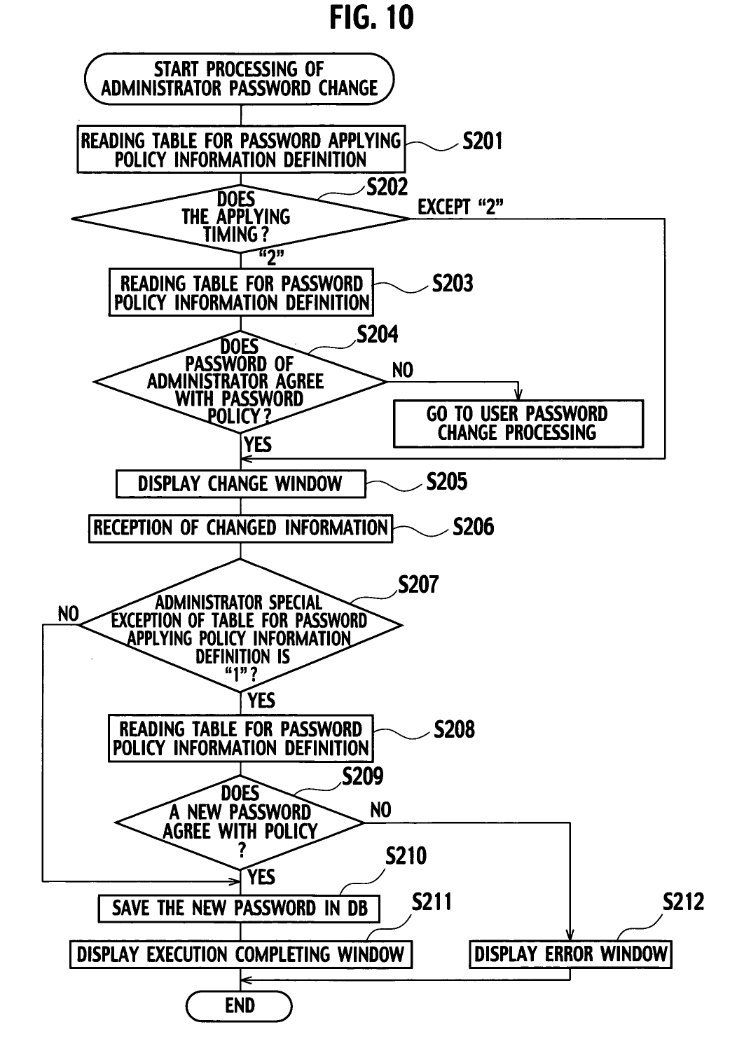

(b) In Step S103, the password policy information setting unit 15a shown in FIG. 2 receives the signal of request for password policy setting information. Next, in Step S104, the password policy information setting unit 15a displays the password policy information setting window 25 shown in FIG. 8 on output unit 12. In addition, the password policy information setting unit 15a urges the system administrator to input the setting value of the each item of password policy information and the setting value of the each item of password applying policy information. Moreover, in Step S105, in the case of changing the customizing policy information, the processing goes to Step S107. In step S105, if a function identifier is input to the column of customizing policy of the password policy information setting window 25 shown in FIG. 8, and a display button 19 is further clicked using the input unit 11, the password policy information setting unit 15a displays a customizing policy setting window 26 shown in FIG. 9 for displaying functional area on output unit 12 in Step S106. The system administrator inputs and updates the function for setting the customizing policy information in the functional area displayed on the customizing policy information setting window 26. The programming language used to set the customizing policy information is not especially limited, and therefore only has to be possible to make the function. The customizing policy information input and updated is then stored in the function area storage 18.

Specifically, as shown in FIG. 9, the customizing policy information is a function to output the return value indicating whether or not the input password being permitted when the internal ID, the login ID, and the password are input as arguments. The customizing policy information includes the character string etc. not permitted as the password. In the case where these no permission characters are input as the password, the customizing policy information outputs the return value indicating no permission. Moreover, the customizing policy information may be a function for acquiring the user authentication information such as user's date of birth using the internal ID input as the argument as a search key, and then may be a function for outputting the return value indicating acquired user authentication information not being permitted as the password. Here, although the case where both of the internal ID and the login ID are input as the argument is described, it may be only either the internal ID or the login ID.

(c) In Step S107, when a save button on the password policy information setting window 25 shown in FIG. 8 is clicked using the input unit 11, the password policy information setting unit 15a acquires each changed set up information. In Step S108, the password policy information setting unit 15a stores each set up information acquired at Step S107 in both of the password policy information definition storage section 17a and the password applying policy definition storage section 17b in the policy information definition storage 17 shown in FIG. 2.

(d) In Step S109, when the password modification function button 24b is selected on the administrator function menu window 24 is received, password change processing is executed in Step S110.

Next, the password change processing in Step S110 shown in FIG. 6 is described referring to the flow chart of FIG. 10. This processing corresponds to the “2. Password change processing performed by the administrator”.

(a) The password change function button 24b is selected using the input unit 11 by the system administrator on the administrator function menu window 24 shown in FIG. 7. In Step S201, the password check unit 15e reads the password applying policy information from the table 22 for the password applying policy information definition shown in FIG. 4. In Step S202, the password check unit 15e branches processing according to the setting value of the applying timing of read password applying policy information. If the applying timing is set as “2: At the next time when the page will be displayed”, the processing goes to Step S203, or otherwise the processing goes to Step S205.

(b) In step S203, the password check unit 15e reads the password policy information from the table 21 for the password policy information definition shown in FIG. 3. In step S204, the password check unit 15e further discriminates whether or not the password of the administrator of the information system agrees with the password policy information when logging in at Step S100. If the administrator password disagrees with the password policy information, this processing goes to user password change processing. Details of the user password change processing will be described later.

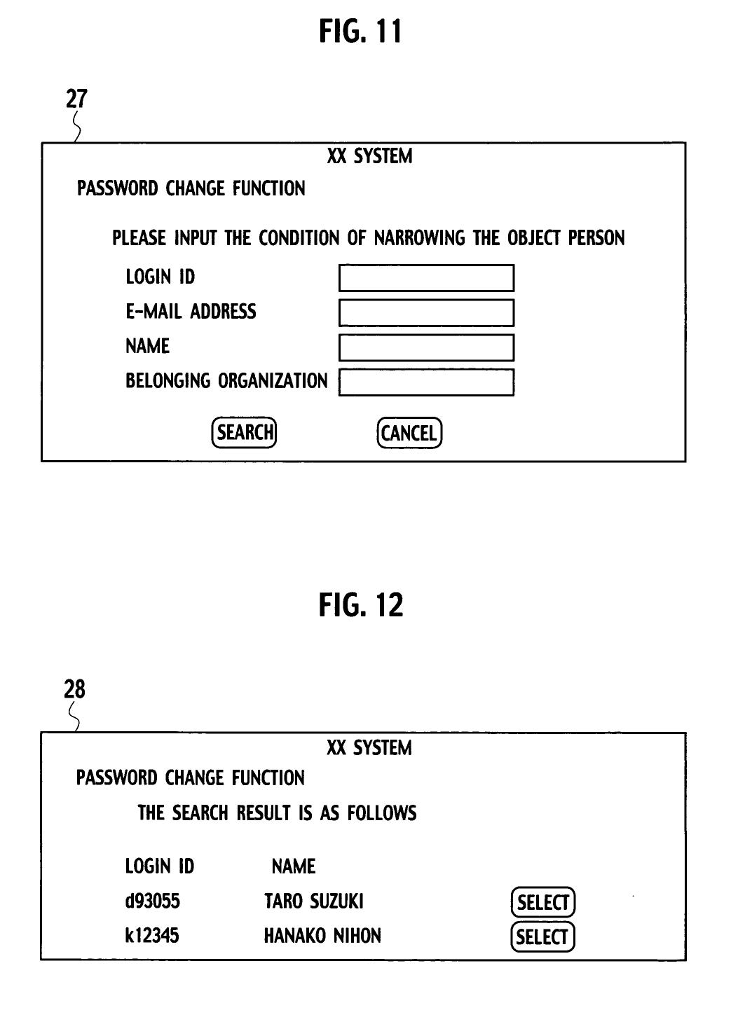

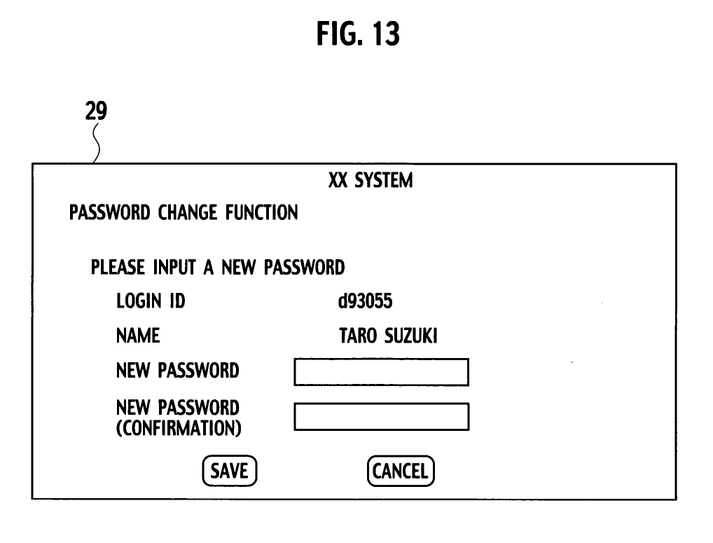

(c) In Step S205, the administrator password change unit 15b displays a user retrieval window 27 for the password change shown in FIG. 11 on the output unit 12. The administrator password change unit 15b urges the administrator of the information system to input at least one or more search conditions such as the login ID, the mail address, names, and the belonging organizations of the user for changing the password to the user search window 27. When a search button is clicked using the input unit 11 after this search condition is input, the administrator password change unit 15b displays the search result on a user select window 28 shown in FIG. 12, and then urges to select the user for changing the password to the system administrator. When the user for changing the password is selected, the administrator password change unit 15b displays a password change window 29 shown in FIG. 13 on the output unit 12, and then urges to input of a new password. In Step S206, when a save button of the password change window 29 shown in FIG. 13 is clicked using the input unit 11, the administrator password change unit 15b receives the new password of the user who changed the password.

(d) In Step S207, the administrator password change unit 15b checks whether or not the administrator special exception is set to “1: Applying when the administrator registers and/or changes” referring to the table 22 for the password applying policy information definition read at Step S201. If the administrator special exception is set to “1: Applying when the administrator registers and/or changes”, in step S208, the administrator password change unit 15b reads the password policy information from the table 21 for the password policy information definition. According to this processing, which is the processing of reading the password policy information from the table 21 for the password policy information definition in step S201, it is possible to correspond even if the reading of the table 21 for the password applying policy definition is not executed at Step S203, especially even if the applying timing is set as the exception of “2” and the administrator special exception is set to “1”.

Next, the administrator password change unit 15b discriminates whether or not the new password received at Step S209 agrees with the password policy information in the table 21 for the password policy information definition read in at Step S208. As a result of discrimination, if the new password agrees with the password policy information, the processing goes to Step S210. On the other hand, if the new password disagrees with the password policy information, the error window is displayed on the output unit 12 in step S212.

(e) In Step S210, the administrator password change unit 15b stores the new password in the table 23 for the user authentication information shown in FIG. 5, and updates the item such as a past password and last password changed dates. Finally, in Step S211, the administrator password change unit 15b displays an execution completing window of the change password on the output unit 12, and then ends this processing.

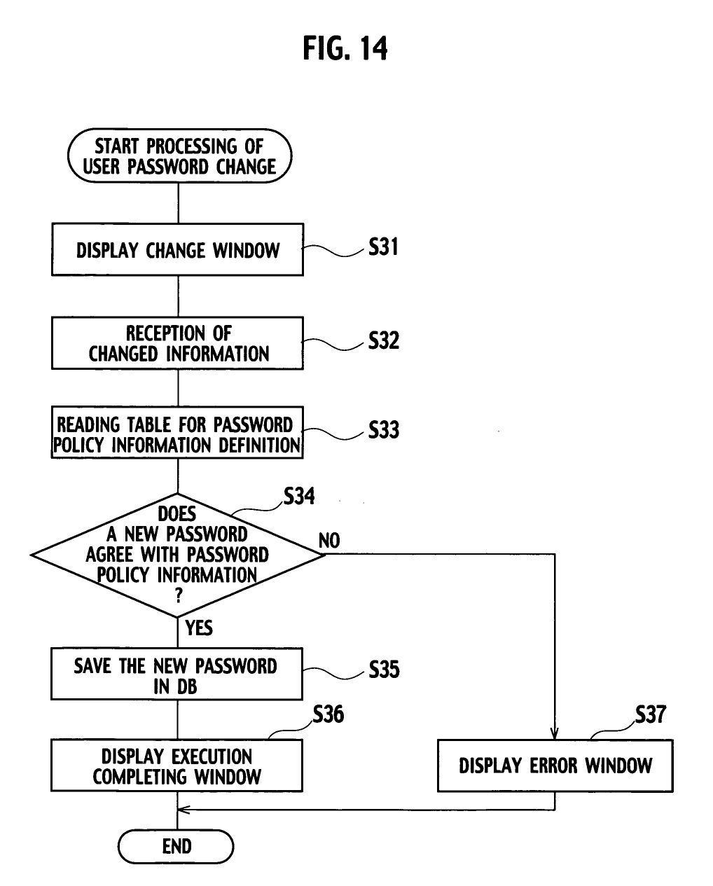

Next, the processing of “3. Password change processing performed by the user” is described referring to the flow chart shown in FIG. 14.

(a) Firstly, in Step S31, the user password change unit 15c displays a password change window 29 as shown in FIG. 13 on the output unit 12, and urges the user or the system administrator to input the a new password. After the new password is input, in Step S32, if a save button of the password change window 29 is clicked using the input unit 11, the user password change unit 15c receives the input new password.

(b) In Step S33, the password check unit 15e reads the password policy information from the table 21 for the password policy information definition shown in FIG. 3, and then discriminates whether or not the received new password agrees with the password policy information in Step S34. As a result of the discrimination, if the received new password agrees with the password policy information, in Step S35, the user password change unit 15c stores the new password in the table 23 for the user authentication information shown in FIG. 5, and then updates the item such as a past password and last password changed dates. Finally, in step S36, the user password change unit 15c displays an execution completing window of the change password on the output unit 12, and then ends this processing.

(c) On the other hand, as a result of the discrimination at Step S34, if the received new password disagrees with the password policy information, the user password change unit 15c displays an error window on the output unit 12 in Step S37, and then ends this processing. In addition, it is not necessary to refer to the table 22 for the password applying policy information definition shown in FIG. 4 in the user password change processing described referring to FIG. 14. Since the user password change unit 15c is a sub routine for always discriminating whether or not the new password agrees with the password policy information, the confirmation of the applying timing of password applying policy information is unnecessary.

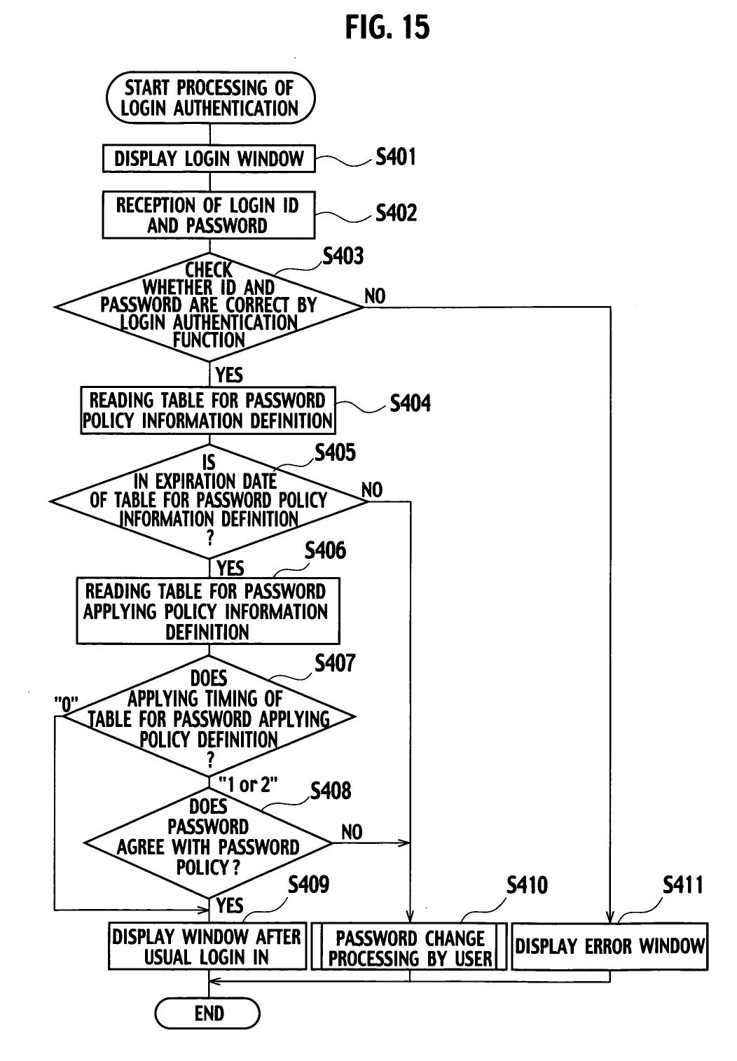

Next, “4. Login authentication processing” is described referring to the flow chart shown in FIG. 15. This processing corresponds to the processing of step S100 shown in FIG. 6.

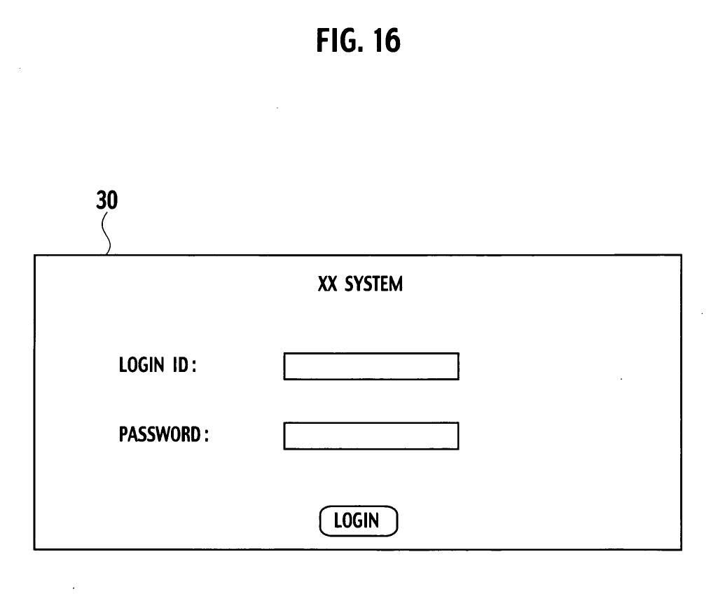

(a) Firstly, in Step S401, the login authentication unit 15d displays a login window 30 shown in FIG. 16 on the output unit 12, and then urges the user or the system administrator to input the login ID and the password in the login window 30. If the login ID and the password are input in the login window 30, and then a login button is clicked using the input unit 11, the login authentication unit 15d receives the input login ID and the received password in step S402.

(b) In Step S403, the login authentication unit 15d checks whether or not the received login ID and the received password are valid by referring to the table 23 for the user authentication information shown in FIG. 5. As a result of the check, if the received login ID and the received password are valid, this processing goes to Step S404. On the other hand, if the received login ID and the received password are invalid, the login authentication unit 15d displays an error window on the output unit 12 in Step S411.

(c) In step S404, the password check unit 15e reads the expiration date information from the table 21 for the password policy information definition shown in FIG. 3, and then checks whether or not the received password is within the expiration date defined by the table 21 for the password policy information definition in Step S405. As a result of the check, if the received password is within the expiration date, this processing goes to Step S406. On the other hand, if the received password is after the expiration date, in Step S410, the password check unit 15e displays the password change window 29, and then the user password change unit 15c urges the user to input a new password.

(d) In step S406, the password check unit 15e reads the password applying policy information from the table 22 for the password applying policy information definition shown in FIG. 4, and then checks the applying timing for the password applying policy information in step S407. As a result of the check, if the applying timing is set to “1: At the next time when logged in” or “2: At the next time when the page will be displayed”, this processing goes to Step S408. On the other hand, if the applying timing is set to “0: At the next time when password will be changed”, this processing goes to Step S409.

(e) In Step S408, the password check unit 15e checks whether or not the password received at Step S402 agrees with the password policy information by referring to the table 21 for the password policy information definition read at Step S404. As a result of the check, if the password agrees with the password policy information, this processing goes to Step S409. In Step S409, in the case of the usual window after login, for example, login by the system administrator, the password check unit 15e displays the administrator function menu window 24 shown in FIG. 7. In the case of login by the user, the password check unit 15e displays the password change window 29 shown in FIG. 13. On the other hand, if the password disagrees with the password policy information, in step S410, the password check unit 15e displays the password change window 29, and then the user password change unit 15c urges the user to input a new password.

As explained above, it is possible to provide for plural password policy information according to the password policy information management server 1 according to the embodiments of the present invention. Further, according to the embodiments of the present invention, the administrator can select the applying timing of password policy information without stopping the system, in order to set whether the disable or enable of the password policy information and to update of the setting value of the password policy information.

Furthermore, the system administrator can independently define the policy information according to the customizing policy information. Therefore, according to the embodiments of the present invention, policy information agreed with the system operation can be added except to the basic password policy information built in the system.

Moreover, the password applying policy information is set in the embodiments of the present invention. Therefore, when the password policy information is changed, it is possible to select the timing in which the changed password policy information is applied to the user, and the timing in which the password is set to be valid for a new password policy.

It is possible to flexibly correspond to the operation mode of the system and the change of the operation policy by the above effects according to the embodiments of the present invention.

### Other Embodiment

Although the embodiments of the present invention have been explained, the present invention may be embodied in other specific forms without departing from the spirit or essential characteristics thereof. A variety of alternative embodiments, implementation examples, and the operation techniques are clear for those skilled in the art from this disclosure.

For example, the password policy information management server 1 described in the embodiments of the present invention may be composed on the single hardware as shown in FIG. 1 or FIG. 2, and also may be composed so that mutually communication with plural hardware such as database servers may enable according to the function and the number of processing. Moreover, the password policy information management server 1 may be operated from the client device through the communication network.

The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A server for management of password policy information in order to check validity of a password of an administrator of an information system and a password of a user using the information system, the server comprising:
a storage including
a password policy information definition storage section storing the password policy information used at the time of one of the administrator and the user of the information system deciding the password, and
a password applying policy information definition storage section storing password applying policy information including timing information, said password being possible to be changed, and said timing information applying the password policy information after the password changed;
a setting unit configured to allow the administrator of the information system to set the password policy information, and to store the password policy information in the password policy information definition storage section, said setting unit further configured to allow the administrator of the information system to set the password applying policy information, and to store the password applying policy information in the password applying policy information definition storage section; and
a password check unit configured to read the password policy information stored in the password policy information definition storage section from the storage, and to check validity of the password using the password policy information.

2. The server of claim 1, wherein
the password policy information includes customizing policy information, and
the setting unit further allows the administrator of the information system to set the customizing policy information independently.

3. The server of claim 1, further comprising
an administrator password change unit configured to request validity checking of a new password to the password check unit according to timing defined by the password applying policy information stored in the password applying policy information definition storage section, and to urge the administrator to change the new password in the case where aforesaid new password is invalid for the password policy information as a result of the check.

4. The server of claim 1, wherein
the password policy information includes at least one of limitation information of the number of characters used for the password, regard information with login ID for logging in the information system, history management information, expiration date information, character limitation information, and customizing policy information.

5. A computer implemented method for management of password policy information in order to check validity of a password of an administrator of an information system and a password of a user using the information system, the computer implemented method comprising:
allowing the administrator of the information system to set the password policy information used at the time of one of the administrator and the user of the information system deciding the password, and storing the password policy information in a password policy information definition storage section included in a storage;
allowing the administrator of the information system to set password applying policy information including timing information and storing the password applying policy information in the password applying policy information definition storage section included in the storage, said password being possible to be changed, and said timing information applying the password policy information after the password changed; and
reading the password policy information stored in the password policy information definition storage section from the storage, and checking validity of the password by a password check unit.

6. The computer implemented method of claim 5, wherein
the password policy information includes customizing policy information, and
in the storing the password policy information in a password policy information definition storage section, further allowing the administrator of the information system to set the customizing policy information independently.

7. The computer implemented method of claim 5, further comprising:
requesting validity checking of a new password to the password check unit by an administrator password change unit according to timing defined by the password applying policy information stored in the password applying policy information definition storage section; and
changing the new password by the administrator password change unit in the case where aforesaid new password is invalid for the password policy information as a result of the check.

8. A program product for management of password policy information in order to check validity of a password of an administrator of an information system and a password of a user using the information system, the computer executable program comprising:
allowing the administrator of the information system to set the password policy information used at the time of one of the administrator and the user of the information system deciding the password, and storing the password policy information in a password policy information definition storage section included in a storage;
allowing the administrator of the information system to set password applying policy information including timing information and storing the password applying policy information in the password applying policy information definition storage section included in the storage, said password being possible to be changed, and said timing information applying the password policy information after the password changed; and
reading the password policy information stored in the password policy information definition storage section from the storage, and checking validity of the password by a password check unit.

9. The program product of claim 8, the computer executable program wherein
the password policy information includes customizing policy information, and
further allowing the administrator of the information system to set the customizing policy information independently.

10. The program product of claim 8, the computer executable program further comprising:
requesting validity checking of a new password to the password check unit by an administrator password change unit according to timing defined by the password applying policy information stored in the password applying policy information definition storage section; and
changing the new password by the administrator password change unit in the case where aforesaid new password is invalid for the password policy information as a result of the check.
